(19) United States
(12) Patent Application Publication
(10) Pub. No.: US 2005/0128503 A1
(43) Pub. Date: Jun. 16, 2005

(54) Information processing apparatus and image-forming system

(75) Inventor: Hideki Matsushita, Yamatokoriyama-shi (JP)

Correspondence Address: NIXON & VANDERHYE, PC, 1100 N GLEBE ROAD, 8TH FLOOR, ARLINGTON, VA, 22201-4714, US

(73) Assignee: SHARP KABUSHIKI KAISHA, Osaka (JP)

(21) Appl. No.: 11/008,617

(22) Filed: Dec. 10, 2004

(30) Foreign Application Priority Data
Dec. 15, 2003 (JP) 2003-416673

(51) Int. Cl. G06F 15/00

(52) U.S. Cl. 358/1.13; 358/1.15; 358/448

(57) ABSTRACT

An information processing apparatus is connected via a network to a plurality of image-forming apparatuses each having a different set of functional printing conditions. The information processing apparatus has a printing condition acquiring section which acquires functional printing conditions for each image-forming apparatus via the network and a control section which, by comparing an input printing condition inputted from an input section with the functional printing conditions for each of the image-forming apparatuses, selects the image-forming apparatus capable carrying out the input printing condition inputted from the input section. The control section, judging an unavailable printing condition for the selected image-forming apparatus, judges the reason for the printing condition thus judged to be unavailable based on functional printing conditions by image-forming apparatuses which are not selected by the control section. Further, the information processing apparatus comprises a display section which displays the unavailable printing conditions and the reasons thereof.

### CROSS REFERENCE

This Nonprovisional application claims priority under 35 U.S.C. § 119 (a) on Patent Application No. 2003-416673 filed in Japan on Dec. 15, 2003, the entire contents of which are hereby incorporated by reference.

### BACKGROUND OF THE INVENTION

The present invention relates to an information processing apparatus and an image-forming system, and more particularly, to an information processing apparatus which is connected to a plurality of image-forming apparatuses each having different functional printing conditions via a network, and an image-forming system including the information processing apparatus.

By connecting an information processing apparatus represented by PC (a personal computer) etc. to a plurality of image-forming apparatuses each of which is able to perform specific printing conditions such as double-side printing or color printing or the like via a network, printing is performed by selecting an image-forming apparatus which can perform a desired printing condition. In this case, in the information processing apparatus which outputs a printing instruction, it is important to improve the usability to be able to recognize the functional printing conditions of each image-forming apparatus.

Therefore, in accordance with a setting condition such as installation of a normal cartridge, or installation of a photo cartridge, or the like, there is disclosed a technology to display restrictively only printing conditions which can be set on a display apparatus. (See Japanese Patent Application Laid-Open No. H11-085422.) However, the technology disclosed in Japanese Patent Application Laid-Open No. H11-085422 is a technology which is applicable only for selected, specific printing apparatuses, but not a technology which can be used for a plurality of printing apparatuses connected together.

As a printing technology for a plurality of printing apparatuses connected, when an information processing apparatus has a functional printing condition for each of the plurality of printing apparatuses, but when a user does not have a printing apparatus appropriate for a desired printing condition set by the user, there is disclosed a technology which outputs a printing instruction as close as possible to the functional printing condition to a printing apparatus. (See Japanese Patent Application Laid-Open No. 2002-132475.)

According to the technology disclosed in Japanese Patent Application Laid-Open No. 2002-132475, an information processing apparatus is given a functional printing condition for each of a plurality of printers. When an appropriate printer is available, the information processing apparatus outputs a printing instruction to the printer, and even when an appropriate printer is not available, it can output a printing instruction to the printer which can perform a printing condition closest to the desired condition. In this regard, it can be regarded as an excellent technology.

However, with the technology disclosed in Japanese Patent Application Laid-Open No. 2002-132475, for example, a color printer having no double-side printing function and a monochrome printer having a double-side printing function are connected to an information processing apparatus. When both printing conditions for color printing and double-side printing are set, the information processing apparatus recognizes as if there would be no functional printer. In such a case, there remain problems with regard to the process to easily inform an operator why no printer is functional, or how to make the printer functional.

### SUMMARY OF THE INVENTION

One feature of the present invention, by informing an operator of the reason why a printing condition is not functional, is to provide an information processing apparatus and an image-forming system with which the operator can easily understand a method to change a printing condition.

Another feature of the present invention is to provide the information processing apparatus and the image-forming system which allow printing in a printing condition closest to a request by the operator.

According to an embodiment of the present invention, the information processing apparatus is connected to a plurality of image-forming apparatuses each having a different set of functional printing conditions.

The information processing apparatus comprises a display section which displays a plurality of printing conditions, an input section which accepts input operations so as to input a desired printing condition among the plurality of printing conditions displayed on the display section as an input printing condition, and a printing condition acquiring section which acquires functional printing conditions from each image-forming apparatus. Therefore, the information processing apparatus grasps functional printing conditions in each of the plurality of image-forming apparatuses connected thereto via a network.

The information processing apparatus comprises a control section which selects an image-forming apparatus which is able to perform an input printing condition inputted from the input section and outputs a printing instruction to a selected image-forming apparatus.

Furthermore, the control section comprises a first judgment section which judges an unfunctional printing condition for a selected image-forming apparatus and a second judgment section which judges the reason why the printing condition is judged to be unfunctional by the first judgment section based on the functional printing conditions for the image-forming apparatuses which are not selected by the control section, and the display section displays the unfunctional printing conditions and the reasons thereof. Therefore, the operator is able to reset a desired printing condition, as the printing conditions and the reasons are displayed on the display section.

### BRIEF DESCRIPTION OF THE DRAWINGS

FIG. 1 is a block diagram showing the functional structure of the outline of an image-forming system according to an embodiment of the present invention;

FIG. 2 is a drawing showing the function of each image-forming apparatus;

FIG. 3 is a flow chart showing a part of processing steps of a control section of an information processing apparatus;

FIG. 4 are drawings showing an example of a setup screen of an input printing condition (input printing function): FIG. 4A shows a state before an operator changes a setup, and FIG. 4B shows a state after the operator changes the setup;

FIG. 5 is a drawing showing another example of a setup screen of an input printing condition (input printing function); and

FIG. 6 is a drawing showing one more example of a setup screen of an input printing condition (input printing function).

### DETAILED DESCRIPTION OF THE INVENTION

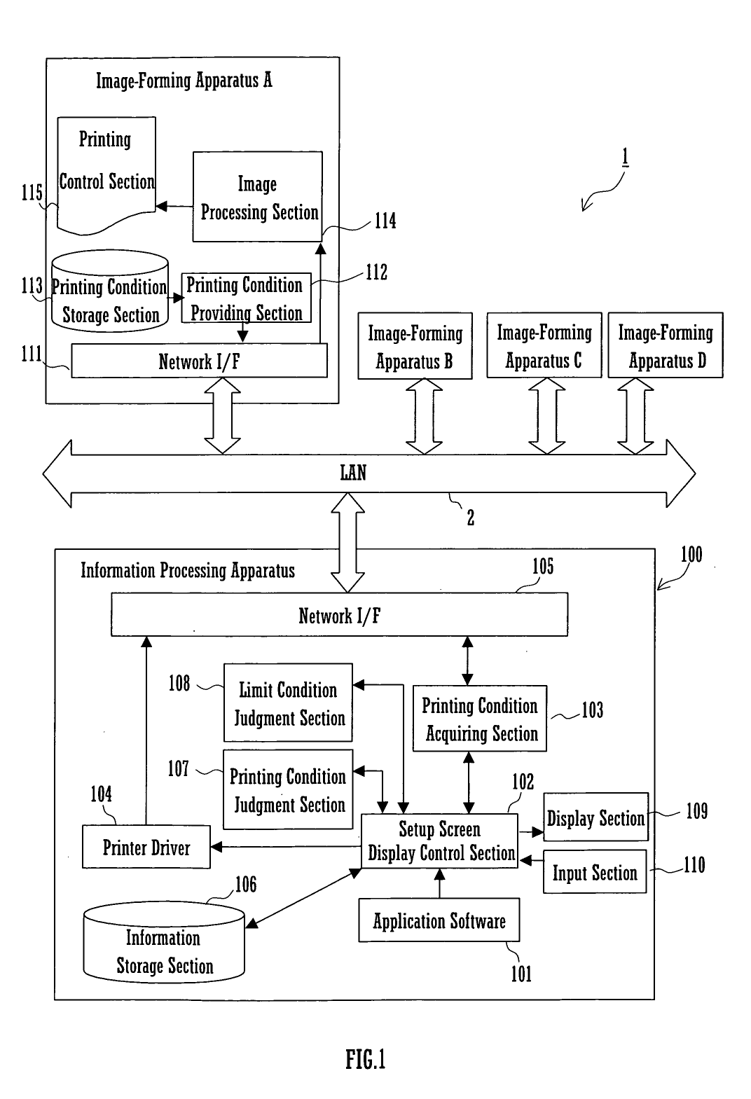

Hereinafter, an image-forming system 1 according to a preferred embodiment of the present invention will be explained by referring to the drawings. FIG. 1 is a block diagram showing the functional structure of the outline of the image-forming system 1. The image-forming system 1 comprises an information processing apparatus 100 and 4 sets of image-forming apparatuses A to D each connected to the information processing apparatus 100 via LAN (local area network) 2.

The information processing apparatus 100 comprises an application software 101 in which prescribed processing steps are programmed, a setup screen display control section 102, a display section 109 which displays various kinds of information, an input section 110 which accepts input operations from an operator, a printing condition acquiring section 103, an information storage section 106, a printing condition judgment section 107, a limit condition judgment section 108, a printer driver 104 of image-forming apparatuses A to D, and a network I/F 105. The control section is composed of the application software 101, the setup screen display control section 102, the printing condition acquiring section 103, the information storage section 106, the printing condition judgment section 107, and the limit condition judgment section 108. As the display section 109, for example, a liquid crystal touch panel is used here.

The setup screen display control section 102, in accordance with an instruction from the application software 101, outputs the instruction to the printing condition acquiring section 103 to acquire a printing condition of each of the image-forming apparatuses Ato D. The printing condition acquiring section 103, in accordance with an instruction from the setup screen display control section 102, is connected to the LAN 2 via the network I/F 105 and also obtains information regarding the printing condition of each of the image-forming apparatuses A to D connected to the LAN 2. The obtained information regarding the printing condition of each of the image-forming apparatuses A to D is stored in the information storage section 106 by the setup screen display control section 102 and also is displayed on the display section 109. Here, the information regarding the printing condition includes functional printing functions for each of the image-forming apparatuses A to D and the status thereof. Hereinafter, the printing condition is referred to simply as the printing function.

And, when a desired printing function selected by an operator among the printing functions displayed on the display section 109 is inputted from the input section 110 as an input printing function, the setup screen display control section 102 outputs the input printing function to the printing condition judgment section 107. The printing condition judgment section 107, based on the input printing function, judges unfunctional printing functions and outputs its judgment result to the setup screen display control section 102. The setup screen display control section 102 displays the inputted judgment result on the display section 109.

In addition, the setup screen display control section 102 outputs the functional printing functions for each of the image-forming apparatuses A to D inputted from the printing condition acquiring section 103, the input printing function inputted from the input section 110, and the judgment result inputted from the printing condition judgment section 107 to the limit condition judgment section 108. The limiting condition judgment section 108, based on the inputted information, judges the reason for each unfunctional printing function and outputs its judgment result to the setup screen display control section 102. The setup screen display control section 102 compares the inputted judgment result inputted from the limit condition judgment section 108 with the judgment result inputted from the printing condition judgment section 107 and displays the outcome on the display section 109. Accordingly, on the display section 109 the unfunctional printing function for the input printing function inputted by the operator is displayed together with the reason corresponding to thereto.

When the operator makes a final decision on the input printing condition based on the information displayed on the display section 109, the setup screen display control section 102, based on the decided printing function, outputs a printing instruction to the printer driver 104 of the image-forming apparatuses A to D (either one of them) which can perform the finally decided input printing function.

Each of the image-forming apparatuses A to D comprises a network I/F 111, a printing condition providing section 112, a printing condition storage section 113, an image processing section 114, and a printing control section 115. The printing condition storage section 113 stores functional printing functions for each of the image-forming apparatuses A to D, and, when the printing condition acquiring section 103 of the information processing apparatus 100 inquires a printing function, the printing condition providing section 112 of each of the image-forming apparatuses A to D reads out information regarding the printing function from the printing condition storage section 113 and provides the printing function to the information processing apparatus 100 via the network I/F 111. In addition, when a printing instruction is inputted from the information processing apparatus 100, the image processing section 114, after performing a prescribed image processing for an image data inputted, outputs the processed image data to the printing control section 115. The printing control section 115 forms an image based on the inputted image data.

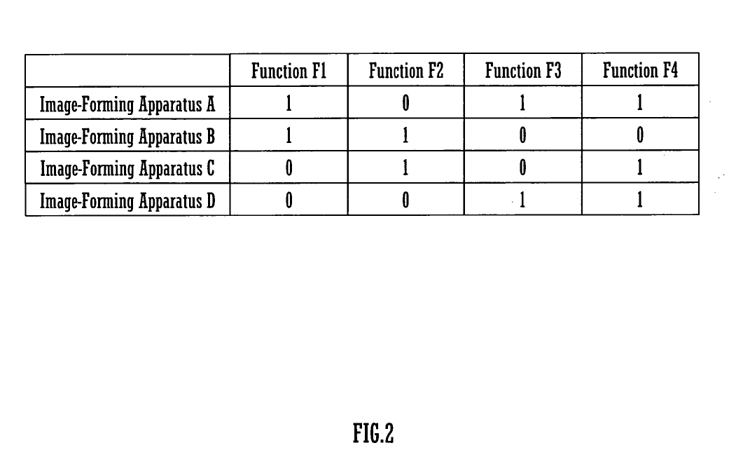

Each of the image-forming apparatuses A to D has a different set of printing functions. The phrase “set of printing functions” as used herein includes one or more printing functions. According to this embodiment, for example, each of the image-forming apparatuses A to D has some of printing functions F1 to F4 as shown in FIG. 2. In FIG. 2, numeral “1” indicates the case where the printing function is functional, while numeral “0” indicates the case where the printing function is unfunctional. For example, the image-forming apparatus A is shown to have the printing functions of F1, F3, and F4. Further, the printing functions F1 to F4 as printing conditions refer to specifically double-side printing function or color printing function or the like, but, as printing functions, it is possible to set information showing operational conditions such as an error status of each of the image-forming apparatuses A to D.

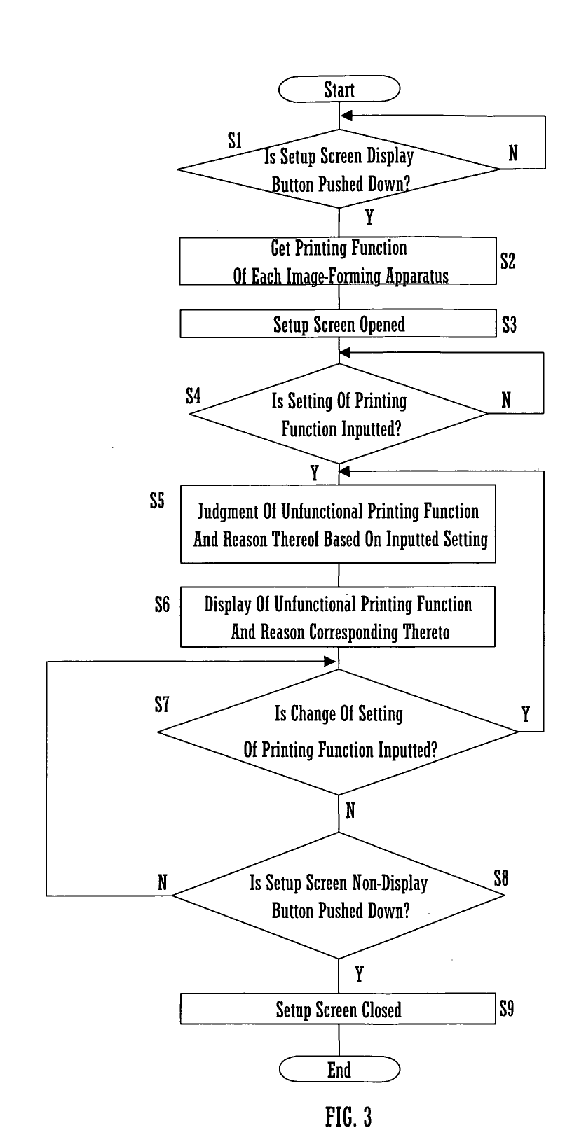

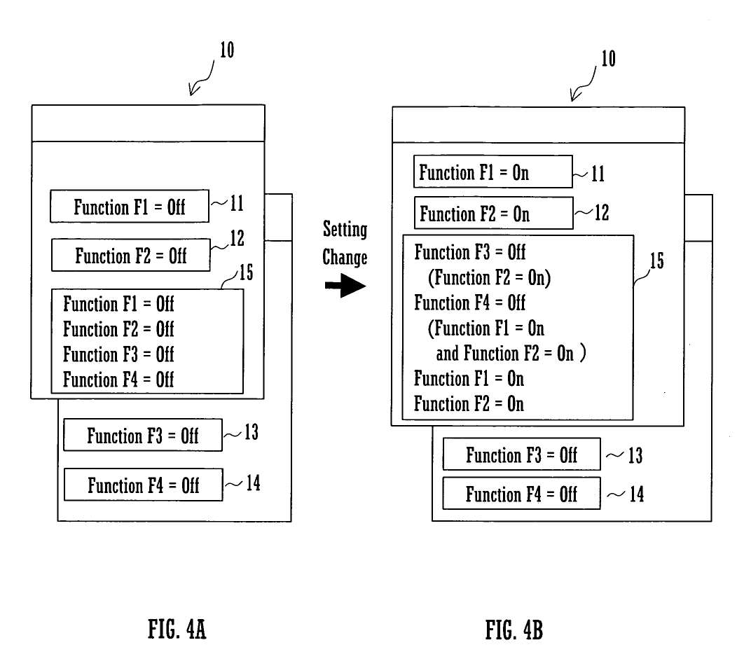

FIG. 3 is a flow chart showing a part of the processing steps of the control section of the information processing apparatus 100. FIG. 4 shows an example of the setup screen of the printing function. When an operator sets a printing function prior to printing, the setup screen display control section 102 of the control section judges whether a setup screen display button (not shown) is pushed or not (S1). When the setup screen display control section 102 judges that the setup screen display button is not pushed, the step S1 is repeated, and when it is judged that the setup screen display button is pushed, the information regarding the printing function of each of the image-forming apparatuses A to D through the printing condition acquiring section 103 is obtained (S2) and stored in the information storage section 106.

And, the setup screen display control section 102 opens the setup screen 10 as shown in FIG. 4A (S3), and judges whether a setting of the printing function was inputted or not by the operator (whether the input printing function was set or not) (S4). The setting of the input printing function by the operator is performed by using function setting buttons 11 to 14. The setup screen display control section 102 repeats the step S4 when the input printing function is not set by the operator, and when the input printing function is set by the operator, the setup screen display control section 102, based on the input printing function inputted, judges the unfunctional printing function and the reason thereof by using the printing condition judgment section 107 and the limit condition judgment section 108 (S5).

In the following, based on the input printing function to be set, a judgment method to judge the nonfunctional printing function and the reason thereof will be explained.

As shown in FIG. 2, whether each of the image-forming apparatuses A to D is functional or unfunctional is indicated by numeral “1” or “0”, respectively. For example, the printing function of the image-forming apparatus A is indicated by “1011”, in order from the function F1 to F4. The printing condition judgment section 107 performs AND (logical product) operation between the printing function of each of the image-forming apparatuses A to D and the input printing function set by the operator, and judges that, in the image-forming apparatus in which the operation result becomes identical to the input printing function (setting value), the printing is possible for the input printing function inputted.

For example, when “the function F2=ON” is set by the operator, the input printing function becomes “0100” and the result of AND (logical product) operation between the printing function of each of the image-forming apparatuses A to D and the input printing function inputted is given by the following expression (1):
the image-forming apparatus A: 1011 AND 0100=0000
the image-forming apparatus B: 1100 AND 0100=0100
the image-forming apparatus C: 0101 AND 0100=0100
the image-forming apparatus D: 0011 AND 0100=0000 Expression (1):

In this case, the image-forming apparatuses for which the result of AND operation is the same as the input printing function (setting value) are the image-forming apparatuses B and C. Thus, the image-forming apparatuses that are functional for printing in accordance with the input printing function presently set are judged to be the image-forming apparatuses B and C. Furthermore, XOR (exclusive logic sum) operation is performed between the operation result of Expression (1) and the setting value “0100”, and, depending on whether the operation result is consistent or not with “0000”, it is possible to judge which image-forming apparatuses are functional for printing in accordance with the present input printing function.

When one functional image-forming apparatus cannot be selected by setting functions F1 to F4, and there are a plurality of apparatuses, the operator separately selects a single image-forming apparatus.

In addition, when a plurality of functions, for example, the functions F1 and F2, are set to ON, the input printing function becomes “1100”, and in a manner similar to that described above, AND operation is performed. The result is given by the following expression (2):
the image-forming apparatus A: 1011 AND 1100=1000
the image-forming apparatus B: 1100 AND 1100=1100
the image-forming apparatus C: 0101 AND 1100=0100
the image-forming apparatus D: 0011 AND 1100=0000 Expression (2):

In this case, the image-forming apparatus for which the result of AND operation is the same as the input printing function is only the image-forming apparatus B. Thus, the image-forming apparatuses which are functional for printing in accordance with the present input printing function are judged to be only the image-forming apparatus B.

According to the method described above, among the plurality of image-forming apparatuses A to D connected to the information processing apparatus 100 via LAN 2, the image-forming apparatuses which are functional for printing in accordance with the input printing function inputted at present are identified.

Furthermore, the function F1, for example, can be regarded as an error status, and when an image-forming apparatus is in a normal state where the printing condition is functional, the function F1 is set to “1” as the input printing function. When an image-forming apparatus is in a state where the printing condition is not functional due to an error, the function F1 is set to “0” as the input printing function. This information may be sent to the information processing apparatus 100. According to this arrangement, a more practical functional condition of the printing function including an error status of each of the image-forming apparatuses A to D can be judged.

Since the functional printing functions are different in each of the image-forming apparatuses A to D, when the input printing function to be used is set, unfunctional printing functions may be created contrariwise. In the following, the method will be explained how to judge printing functions which become unfunctional, that is, cannot be set because of the input printing function inputted.

For example, when “function F2=ON” is set, according to the method described above, the image-forming apparatuses B and C are judged to be the image-forming apparatuses which are functional for printing. Then, OR operation on the printing function of these two sets of the image-forming apparatuses B and C yields the following expression (3):
1100 OR 0101=1101 Expression (3):

From the result of OR operation of Expression (3), the image-forming apparatuses B and C, which are selected by setting the input printing function to “function F2=ON”, are judged to be unfunctional to perform the function F3 as a whole.

Similarly, when “function F1=ON” and “function F2=ON” are set as the input printing function, the image-forming apparatus B is selected and is judged to be unable to perform the functions F3 and F4. Accordingly, as shown in FIG. 4B, the display mode such as display color etc. of “function F3=OFF” and “function F4=OFF” corresponding to 2 function setting buttons 13 and 14 is changed, and, by setting the functions F1 and F2 to ON as the input printing function, the operator is informed that the settings of the functions F3 and F4 become impossible.

However, when the functions F1 and F2 are set to ON as the input printing function, the display that the settings of the functions F3 and F4 are impossible to be set does not provide sufficient information by itself. For example, when the function F3 is desired to be used instead of the functions F1 and F2, it is not possible to judge which function should be set to OFF in order to use the function F3, or to understand the reason why the setting of the F3 becomes impossible.

For example, the case in which the function F2 is set to ON after setting the function F1 to ON is compared with the case in which the function F1 is set to ON after setting the function F2 to ON. First, when the function F1 is set to ON, a setting limit (limit to disable setting as the input printing function; hereinafter, the same) to the functions F3 and F4 does not appear. Next, when the function F2 is set to ON, the setting limit to the functions F3 and F4 appears. Therefore, in this case, the operator can judge that the reason for the setting limit to the functions F3 and F4 is due to the fact that the function F2 was set to ON. In addition, first, when the function F2 is set as the input printing function, the setting limit appears only for the function F3, and, next, when the function F1 is set to ON as the input printing function, the setting limit appears also for the function F4. In this case, the operator can judge that the reason for the setting limit to the function F3 is due to the fact that the function F2 was set to ON and that the reason for the setting limit to the function F4 is due to the fact that the function F1 was set to ON. As explained above, the display of “ON” and “OFF” of the function setting buttons 11 to 14 alone cannot provide sufficient information, and the operator cannot obtain precise information.

Accordingly, the information processing apparatus 100 provides a setting detail information screen 15 in the setup screen 10. In the setting detail information screen 15, the setting condition of “ON” or “OFF” of each of the function F1 to F4 and the reason for the setting limit to the function being OFF are displayed. In FIG. 4B, the reason for each setting limit is displayed inside the parentheses following below the setting condition of each input printing function.

In the following, the method to judge the reason for the setting limit will be explained. The judgment of the reason is performed in the limit condition judgment section 108. For example, when “function F1=ON” and “function F2=ON” are set as the input printing function, that is, when the setting value of the input printing function is set to “1100”, the setting limit to the functions F3 and F4 appears as described above. First, the judgment of the reason for the setting limit to the function F3 is performed based on the result of AND operation between the printing function of the image-forming apparatuses A and D which can perform the function F3, that is, “1011” and “0011”, and the setting value “1100” and the result of XOR operation between the result of the AND operation and the setting value “1100”. Specifically, the following expression (4) is obtained. Expression (4) indicates mathematically that the image-forming apparatus A does not have the function F2 out of the functions F1 and F2, and that the image-forming apparatus D has neither the function F1 nor the function F2.
(1011 AND 1100) XOR 1100=0100
(0011 AND 1100) XOR 1100=1100 Expression (4):

According to the results of the operation of Expression (4), the part (part of the function set to ON at present), the setting of the input printing function of which is to be changed in order to remove the setting limit to the function F3, is indicated to be “1”. Therefore, in order to use as many of the functions F1 to F4 as possible, the value which has as few “1” s as possible from the results of Expression (4) is selected. Here, “0100” is selected from the two results of the operation, and it is judged that, if at least the function F2 is set to “OFF”, the setting limit to the function F3 is removed and the function F3 can be set to “ON”.

Next, in a manner similar to the case of the function F3 described above, the judgment of the reason for the setting limit to the function F4 is performed, and Expression (5) is obtained as the result of the operation.
(1011 AND 1100) XOR 1100=0100
(0101 AND 1100) XOR 1100=1000
(0011 AND 1100) XOR 1100=1100 Expression (5):

According to the results of the operation of Expression (5), “0100” and “1000” are selected. It is judged that, when the input printing function of either the function F1 or the function F2 is set to “OFF”, the setting limit to the function F4 is removed and the function F4 can be set to “ON”.

Returning to FIG. 3, let us consider the unfunctional printing functions at the step S5 by the control section as described above and the reason thereof. The setup screen display control section 102 displays the unfunctional printing functions and the reasons corresponding thereto at the front surface of the setup screen 10 (S6).

In the example described above, “function F2=ON” is displayed inside the parentheses below “function F3=OFF” on the setting detail information screen 15 and the operator is informed that the reason for the setting limit to the function F3 is due to the fact that the function F2 is set to ON. Therefore, when the operator desires to set the function F3 to “ON”, it is easily understood that the function F2 is to be set to “OFF”. In addition, “function F1=ON and function F2=ON” is displayed inside the parentheses below “function F4=OFF”, and the operator is informed that the reason for the setting limit to the function F4 is due to both the function F1 and the function F2 being set to “ON”. Therefore, when the operator desires to set the function F4 to “ON”, it can be understood that at least one of the function F1 and the function F2 is to be set to “OFF”.

Next, the setup screen display control section 102 judges whether the setting of the input printing function is changed or not by the operator (S7). When the setting of the input printing function is changed, the setup screen display control section 102 returns to the processing of the step S5, again judges the unfunctional printing function and the reason thereof (S5) based on the input printing function newly set, and displays the outcome on the display section 109 (S6). When the setting of the input printing function is not changed, the setup screen display control section 102 judges whether the setup screen non-display button (not shown) is pushed or not in order to close the setup screen (S8), and, when the setup screen non-display button is not pushed, returns to the processing of the step S7. When the setup screen non-display button is pushed, the setup screen 10 is closed (S9), and the setting processing of the input printing function is completed.

According to the information processing apparatus 100, since the operator can easily understand the unfunctional printing functions and the reasons thereof, it is possible to change easily and appropriately a combination of the printing functions to be used. Therefore, it is possible to perform printing under the condition closest to the desired one among the printing functions having the setting limit.

Further, the method of a series of setting processing described above can be installed in the information processing apparatus 100 as programmed application software.

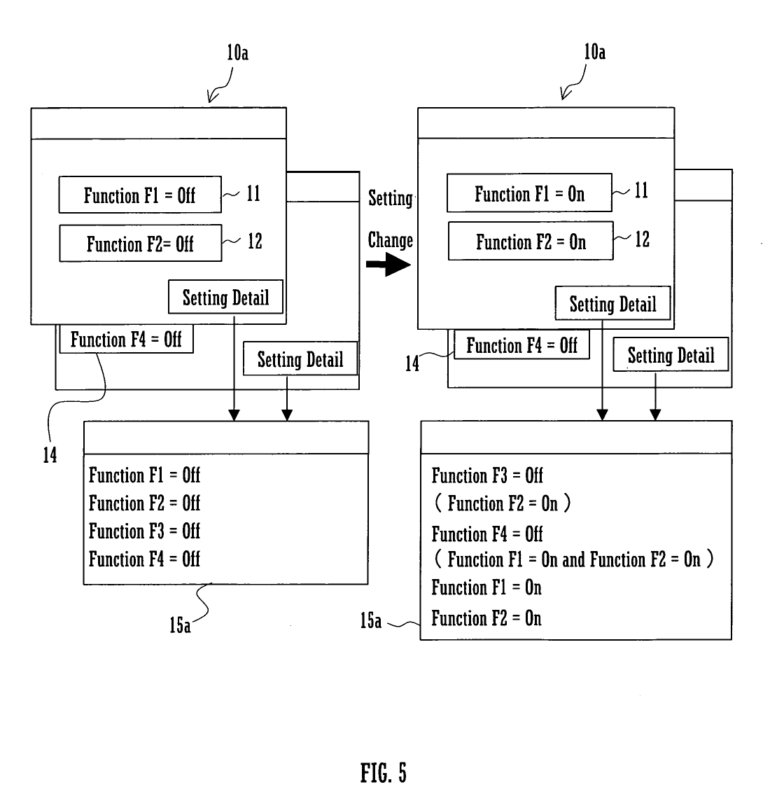

In addition, in case all the information of the setup screen 10 cannot be displayed on the display section 109 simultaneously, the screen may be arranged to be scrolled. Further, as shown in FIG. 5, a part of the setup screen 10a such as the setting detail information screen 15a etc. may be opened as a separate display area. In this case, it may be preferable to display the unfunctional printing conditions at the front surface.

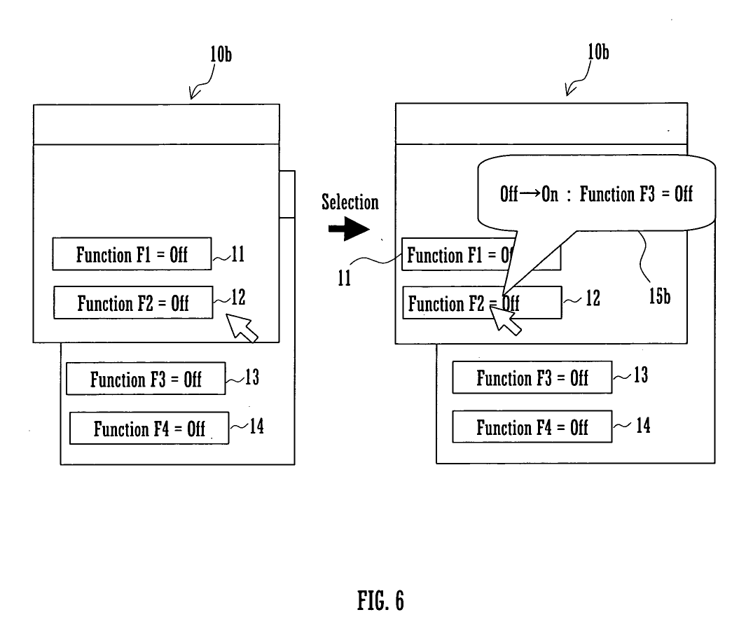

In addition, before the settings of the functions F1 to F4 are changed, it is possible to display the information of which function setting is limited by this change on the setup screen 10b. Specifically, as shown in FIG. 6, the input section is composed of a pointing device which inputs the input printing function by pointing the position of a desired printing function from the plurality of input printing functions displayed on the display section 109, and the control section, when the pointing device is moved to the position of the desired printing function, compares the desired printing function at the moved position with the functional printing function for the image-forming apparatus acquired by the printing condition acquiring section 103 and selects the image-forming apparatus that can perform the desired printing function at the position where the pointing device is moved. In the following, in a manner similar to the case described above, the unfunctional printing condition for the selected image-forming apparatus is judged, the reason why the printing condition is judged to be unfunctional is judged, and these results are displayed.

Furthermore, with regard to the display order of each of the printing functions F1 to F4 on the setting detail information screens 15, 15a, and 15b, it is preferable to display preferentially the printing function having the setting limit. Accordingly, it is possible to lighten operator's burden to search for the printing function having the setting limit.

In addition, with the settings of the printing functions F1 to F4, when the number of functional image-forming apparatuses is more than 1, it may be advisable to set the priority for the image-forming apparatuses A to D in advance. In addition, among the image-forming apparatuses A to D, the image-forming apparatus which has the most of the printing functions F1 to F4 may preferentially be selected, and the function of that image-forming apparatus may be displayed also on the display section 109.

Furthermore, the display of the reason for the setting limit to the printing functions F1 to F4 may be replaced by the display of an instruction for removing the setting limit instead.

In addition, the information storage section 106 may store information in a storage medium provided separately.

While the preferred embodiment of the present invention has been described using specific terms, such description is for illustrative purposes only, and it is to be understood that changes and variations may be made without departing from the spirit or scope of the appended claims.

1. An information processing apparatus connected via a network to a plurality of image-forming apparatuses each having a different set of functional printing conditions, comprising:
a display section for displaying a plurality of printing conditions;
an input section for accepting input operations to input a desired printing condition from the plurality of printing conditions displayed on the display section as an input printing condition;
a printing condition acquiring section for acquiring functional printing conditions for each image-forming apparatus among the plurality of image-forming apparatuses via the network; and
a control section for selecting the functional image-forming apparatus for the input printing condition inputted from the input section by comparing the input printing condition inputted from the input section with the functional printing conditions for each image-forming apparatus acquired by the printing condition acquiring section, and outputting a printing instruction to the selected image-forming apparatus,
wherein the control section comprises a first judgment section for judging an additional printing condition unavailable in the selected image-forming apparatus; and a second judgment section for judging which of the input printing conditions cause the additional printing condition to be unavailable, based on functional printing conditions for the image-forming apparatuses which are not selected by the control section, and
wherein the display section displays the unavailable printing conditions and the cause of the unavailability thereof.

2. The information processing apparatus according to claim 1, wherein the display section displays the unavailable printing conditions and the causes of the unavailability corresponding thereto.

3. The information processing apparatus according to claim 2, wherein the display section displays the unavailable printing conditions at the front surface.

4. The information processing apparatus according to claim 1, wherein the input section comprises a pointing device for inputting the input printing condition by pointing the position of a desired printing condition from the plurality of printing conditions displayed on the display section; the control section, when the pointing device is moved to the position of the desired printing condition, compares the desired printing condition at the moved position with the functional printing condition for the image-forming apparatus acquired by the printing condition acquiring section and selects the functional image-forming apparatus for the desired printing condition at the position where the pointing device is moved; the first judgment section judges the unavailable printing condition for the selected image-forming apparatus; and the second judgment section judges which of the printing conditions cause the additional printing condition to be unavailable.

5. An image-forming system comprising a plurality of image-forming apparatuses each having a different set of functional printing conditions and an information processing apparatus connected to the plurality of image-forming apparatuses via a network, wherein the information processing apparatus comprises:
a display section for displaying a plurality of printing conditions;
an input section for accepting input operations to input a desired printing condition from the plurality of printing conditions displayed on the display section as an input printing condition;
a printing condition acquiring section for acquiring functional printing conditions for each image-forming apparatus among the plurality of image-forming apparatuses via the network; and
a control section for selecting the functional image-forming apparatus for the input printing condition inputted from the input section by comparing the input printing condition inputted from the input section with the functional printing conditions for each image-forming apparatus acquired by the printing condition acquiring section, and outputting a printing instruction to the selected image-forming apparatus,
wherein the control section comprises a first judgment section for judging an additional printing condition unavailable in the selected image-forming apparatus; and a second judgment section for judging which of the printing conditions cause the additional printing condition to be unavailable based on functional printing conditions for the image-forming apparatuses which are not selected by the control section, and
wherein the display section displays the unavailable printing conditions and the cause of unavailability thereof.

6. An information processing program product causing a computer to perform the steps of:
displaying a plurality of printing conditions on a display section equipped in an information processing apparatus, which is connected to a plurality of image-forming apparatus via a network
accepting input operations so as to input a desired printing condition from the plurality of printing conditions displayed on the display section as an input printing condition;
acquiring functional printing conditions for each image-forming apparatus among the plurality of image-forming apparatuses via the network; and
selecting the functional image-forming apparatus for the input printing condition inputted from the input step by comparing the input printing condition inputted from the input step with the functional printing conditions for each image-forming apparatus acquired by the printing condition acquiring step, and outputting a printing instruction to the selected image-forming apparatus,
wherein the control step comprises a first judgment step of judging an additional printing condition unavailable in the selected image-forming apparatus; and a second judgment step of judging which of the input printing conditions cause the additional printing condition to be unavailable, based on functional printing conditions for the image-forming apparatuses which are not selected by the control step, and
wherein the display step displays the unavailable printing conditions and the cause of unavailability thereof.
